(19) United States
(12) Patent Application Publication
(10) Pub. No.: US 2012/0287377 A1
(43) Pub. Date: Nov. 15, 2012

(54) LIQUID CRYSTAL DISPLAY DEVICES AND METHODS OF MANUFACTURING LIQUID CRYSTAL DISPLAY DEVICES

(76) Inventors: Jae-Hyun KIM, Yongin-si (KR); Jae-Ik Lim, Yongin-si (KR); Jeong-Hwan Kim, Yongin-si (KR)

(21) Appl. No.: 13/315,613

(22) Filed: Dec. 9, 2011

(30) Foreign Application Priority Data
May 9, 2011 (KR) 10-2011-0043563

(51) Int. Cl. G02F 1/1333

(52) U.S. Cl. 349/88; 349/187

(57) ABSTRACT

A liquid crystal display device may include a first substrate having a reflective region and a transmissive region, a second substrate corresponding to the first substrate, a first liquid crystal structure disposed between the first substrate and the second substrate in the reflective region, the first liquid crystal structure including first polymer networks and first liquid crystal molecules, and a second liquid crystal structure disposed between the first substrate and the second substrate in the transmissive region, the second liquid crystal structure including second polymer networks and second liquid crystal molecules.

### CLAIM OF PRIORITY

This application claims priority under 35 U.S.C. §119 to Korean patent Application No. 2011-0043563, filed on May 9, 2011, the disclosure of which is hereby incorporated by reference herein in its entirety.

### BACKGROUND

1. Field

Example embodiments of the invention relate to liquid crystal display devices and methods of manufacturing liquid crystal display devices.

2. Description of the Related Art

A liquid crystal display device may display images by controlling a transmittance of light according to an orientation of liquid crystal molecules in a liquid crystal layer by varying an electric field generated between two electrodes. Even though the liquid crystal display may not emit light itself and may need an additional light source, the liquid crystal display has been used widely because of a relatively low power consumption and a desired mobility thereof.

Generally, liquid crystal display devices are classified into transmissive type liquid crystal display devices using internal light sources and reflective type liquid crystal display devices using external light sources. The transmissive type liquid crystal display device, an internal backlight is served as the internal light source, so that the transmissive type liquid crystal display device may display relatively bright images under a relatively dark environment.

A transflective type liquid crystal display having a transmissive region and a reflective region usually includes a lower substrate having a thin film transistor, an upper substrate having a color filter, and a liquid crystal layer disposed between the lower and the upper substrates. In this case, the transflective type liquid crystal display may have a dual cell gap structure in which a cell gap of the transmissive region may be substantially two times larger than a cell gap of the reflective region.

In a conventional transflective type liquid crystal display device, one pixel may have a transmissive region and a reflective region while basically one transistor may simultaneously apply a voltage into the transmissive region and the reflective region. An optical path of an incident light in the reflective region may be about two times larger than a cell gap in the reflective region, so that the optical path of the incident light in the reflective region may need to be reduced by ½ or a retardation of the liquid crystal layer may correspond to ¼ of a wave length of the incident light. As for the conventional transflective type liquid crystal display device, in order to reduce the cell gap in the reflective region, a step may be formed on a lower substrate having a thin film transistor and/or an upper substrate having a color filter.

### SUMMARY

According to example embodiments, there is provided a liquid crystal display device including a first substrate having a reflective region and a transmissive region, a second substrate corresponding to the first substrate, a first liquid crystal structure disposed between the first substrate and the second substrate in the reflective region, the first liquid crystal structure including first polymer networks and first liquid crystal molecules, and a second liquid crystal structure disposed between the first substrate and the second substrate in the transmissive region, the second liquid crystal structure including second polymer networks and second liquid crystal molecules.

In example embodiments, the first liquid crystal molecules may be partially or totally dispersed in the first polymer networks, and the second liquid crystal molecules may be partially or totally dispersed in the second polymer networks.

In example embodiments, at least one of the first and the second liquid crystal structures may include a color dye.

In example embodiments, the liquid crystal display device may additionally include a memory structure disposed on the first substrate in the reflective region and an insulation layer covering the memory structure on the first substrate.

In example embodiments, the liquid crystal display device may additionally include a first electrode disposed on the first substrate in the reflective region and the transmissive region, and a second electrode disposed on the second substrate.

In example embodiments, a first cell gap between the first electrode and the second electrode in the reflective region may be smaller than a second cell gap between the first electrode and the second electrode in the transmissive region.

In example embodiments, the first electrode may be electrically connected to the memory structure.

In example embodiments, the liquid crystal display device may additionally include a reflection layer disposed between the first electrode and the first substrate in the reflective region.

In example embodiments, the reflection layer may include a cholesteric liquid crystal polymer.

In example embodiments, the liquid crystal display device may additionally include a black matrix disposed between the reflection layer and the first substrate.

In example embodiments, the liquid crystal display device may additionally include a color filter disposed between the reflection layer and the first electrode.

In example embodiments, the first electrode may cover exposed surfaces of the reflection layer and the color filter.

In example embodiments, the liquid crystal display device may additionally include a reflection layer disposed on the first substrate in the reflective region, a first electrode disposed on the first substrate in the transmissive region, and a second electrode disposed on the second substrate.

In example embodiments, a first cell gap between the first electrode and the second electrode in the reflective region may be the same size as a second cell gap between the first electrode and the second electrode in the transmissive region.

In example embodiments, the first electrode may make contact with the reflection layer, and the reflection layer may be electrically connected to the memory structure.

In example embodiments, the liquid crystal display device may additionally include a color filter disposed on the second electrode in the reflective region, and a protection layer disposed on the color filter and the second electrode.

In example embodiments, the color filter may include an opening partially exposing the first liquid crystal structure.

According to example embodiments, there is provided a method of manufacturing a liquid crystal display device. In the method, a first electrode may be formed on a first substrate having a reflective region and a transmissive region. A second electrode may be formed on a second substrate substantially corresponding to the first substrate. The first substrate may be combined with the second substrate. A first liquid crystal structure may be formed between the first substrate and the second substrate in the reflective region, the first liquid crystal structure may include first polymer networks and first liquid crystal molecules. A second liquid crystal structure may be formed between the first substrate and the second substrate in the transmissive region. The second liquid crystal structure may include second polymer networks and second liquid crystal molecules.

In example embodiments, the method for manufacturing a liquid crystal display device may further include forming a memory structure on the first substrate in the reflective region prior to foil ling the first electrode, and forming an insulation layer on the first substrate to cover the memory structure prior to forming the first electrode.

In example embodiments, a reflection layer may be formed between the insulation layer and the first electrode in the reflective region.

In example embodiments, a color filter may be formed between the reflection layer and the first electrode.

In example embodiments, a black matrix may be formed between the insulation layer and the reflection layer.

In example embodiments, a reflection layer may be formed on the first substrate in the reflective region, wherein the first electrode is disposed on the first substrate in the transmissive region.

In example embodiments, a color filter may be formed on the second electrode in the reflective region, and a protection layer may be formed on the color filter and the second electrode.

Forming the first and the second liquid crystal structures according to example embodiments may include forming a first preliminary liquid crystal structure in the reflective region, forming a second preliminary liquid crystal structure in the transmissive region, and exposing the first preliminary liquid structure and the second preliminary liquid crystal structure to light.

### BRIEF DESCRIPTION OF THE DRAWINGS

Example embodiments may be understood in more detail from the following description taken in conjunction with the accompanying drawings, in which:

FIG. 1 illustrates a cross sectional view of a liquid crystal display device in accordance with example embodiments;

FIG. 2 illustrates a cross sectional view of an operation of a liquid crystal display device in accordance with example embodiments;

FIG. 3 illustrates a cross sectional view of a liquid crystal display device in accordance with some example embodiments;

FIG. 4 illustrates a cross sectional view of a liquid crystal display device in accordance with some example embodiments;

FIG. 5 illustrates a cross sectional view of a liquid crystal display device in accordance with some example embodiments; and

FIGS. 6 and 7 illustrate cross sectional views of a method of manufacturing a liquid crystal display device in accordance with example embodiments.

### DESCRIPTION OF EMBODIMENTS

Various example embodiments will be described more fully hereinafter with reference to the accompanying drawings, in which some example embodiments are shown. The invention may, however, be embodied in many different forms and should not be construed as limited to the example embodiments set forth herein. Rather, these example embodiments are provided so that this description will be thorough and complete, and will fully convey the scope of the invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, fourth etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” may encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

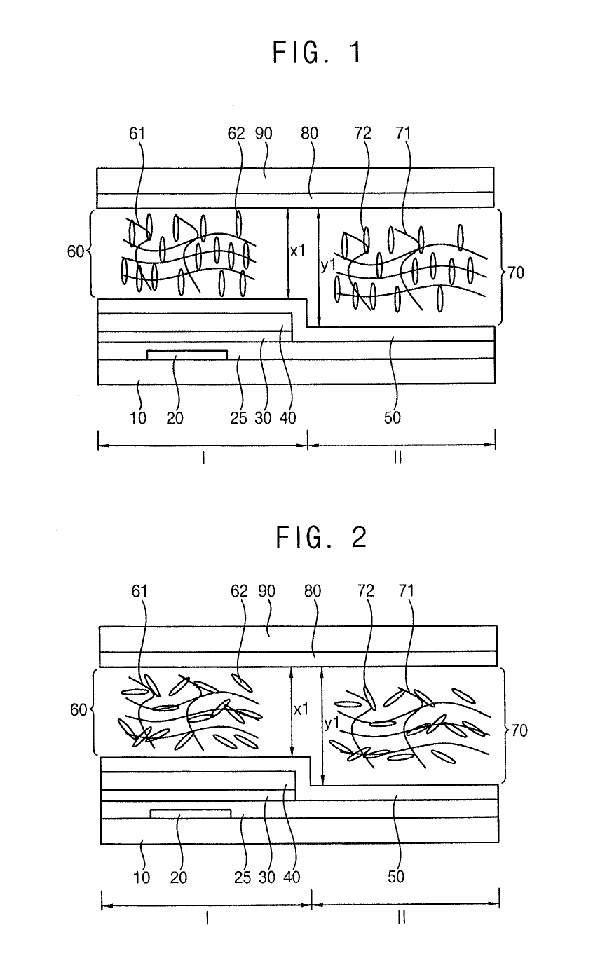

FIG. 1 is a cross sectional view illustrating a liquid crystal display device in accordance with example embodiments.

Referring to FIG. 1, a liquid crystal display device may include a first substrate 10, a memory structure 20, an insulation layer 25, a reflection layer 30, a color filter 40, a first electrode 50, a second substrate 90, a second electrode 80, a first liquid crystal structure 60, and a second liquid crystal structure 70. The first and the second liquid crystal structures 60 and 70 may be disposed between the first substrate 10 and the second substrate 90.

In example embodiments, the liquid crystal display device may include a transflective liquid crystal display device having a reflective region I and a transmissive region II. In this case, the first substrate 10 and/or the second substrate 90 may also include the reflective region I and the transmissive region II.

In example embodiments, the first liquid crystal structure 60 may be positioned in the reflective region I and the second liquid crystal structure 70 may be located in the transmissive region II. The first liquid crystal structure 60 may include first polymer networks 61 and first liquid crystal molecules 62. Additionally, the second liquid crystal structure 70 may include second polymer networks 71 and second liquid crystal molecules 72.

Each of the first substrate 10 and the second substrate 90 may include a transparent insulating material, for example, glass, transparent plastic, transparent metal oxide, etc. In example embodiments, a first face of the first substrate 10 may substantially correspond to a first face of the second substrate 90. That is, the first substrate 10 may substantially face the second substrate 90. Additionally, a second face of the first substrate 10 and a second face of the second substrate 90 may be substantially opposed to the first face of the first substrate 10 and the first face of the second substrate 90, respectively. The liquid crystal display device may have a construction in which the first and the second substrates 10 and 90 are located substantially parallel to each other. Here, the first and the second substrates 10 and 90 may be arranged horizontally or vertically.

Referring to FIG. 1, the memory structure 20, the insulation layer 25, the reflection layer 30, and the first electrode 50 may be disposed on the first substrate 10. The memory structure 20 may be positioned on the first substrate 10 in the reflective region I. The memory structure 20 may include an in-pixel memory structure and may correspond to each pixel of the liquid crystal display device. That is, the liquid crystal display device may include a plurality of memory structures 20 substantially corresponding to a plurality of pixels, respectively. In example embodiments, the memory structure 20 may be located in the reflective region I, so that the reduction in an aperture ratio of the liquid crystal display may be prevented. For example, the memory structure 20 may include a memory device such as a static random access memory (SRAM) device, a dynamic random access memory (DRAM) device, a magneto-resistive random access memory (MRAM) device, etc. Further, the memory structure 20 may include a switching device such as a thin film transistor (TFT) and/or an oxide semiconductor device. Using memory structure 20 having the in-pixel memory construction, the liquid crystal display device may display static images without any refresh process. Thus, a power consumption of the liquid crystal display device may be reduced. Furthermore, when each pixel of the liquid crystal display device includes a memory device, the liquid crystal display device may display various color images using data stored in the memory device without operating a driving circuit for driving the liquid crystal display device. In other words, the liquid crystal display device may display images using the memory structure 20 disposed in each pixel without operating the driving circuit. Thus, the liquid crystal display device may ensure a low power consumption.

The insulation layer 25 may be positioned on the first substrate 10 to cover the memory structure 20. In this case, the insulation layer 25 may include a first opening (not illustrated) partially exposing the memory structure 20. In example embodiments, the insulation layer 25 may be located on the first substrate 10 in the reflective region I. Alternatively, the insulation layer 25 may be disposed on the first substrate 10 in both of the reflective region I and the transmissive region II. The insulation layer 25 may include a transparent insulating material such as transparent plastic, transparent resin, etc.

The reflection layer 30 may be located on the insulation layer 25. The reflection layer 30 may be disposed in the reflective region I of the liquid crystal display device. In example embodiments, the reflection layer 30 may fill the first opening in the insulation layer 25 and may make contact with the memory structure 20. In some example embodiments, contacts (not illustrated), plugs (not illustrated), pads (not illustrated), etc., filling the first opening in the insulation layer 25 may also be provided. According to some embodiments, the reflection layer 30 may be electrically connected to the memory structure 20 through the contacts, the plugs, the pads, etc.

The reflection layer 30 may include a material having a relatively high reflectivity. For example, the reflection layer 30 may include one or more of aluminum (Al), molybdenum (Mo), tungsten (W), chrome (Cr), platinum (Pt), silver (Ag), an alloy thereof, etc. Materials suitable for the reflection layer 30 are not limited to those specifically described herein. In example embodiments, the reflection layer 30 may have a substantially level surface. Alternatively, the reflection layer 30 may include a plurality of protruding portions having a micro lens structure. As such, an efficiency of light incident in the reflective region I may be improved.

In example embodiments, the first liquid crystal molecules 62 in the first liquid crystal structure 60 and the reflection layer 30 may reflect light incident into the reflective region I. The liquid crystal display device may, thereby, achieve an enhanced reflection efficiency, without an additional process for improving a reflectivity of the reflection layer 30, for example, an embossing process.

The color filter 40 may be disposed on the reflection layer 30. In example embodiments, substantially similar to the reflective layer 30, the color filter 40 may be positioned in the reflective region I. That is, the color filter 40 may not exist in the transmissive region II. In example embodiments, the color filter 40 may include red color filters for red (R) light, green color filters for green (G) light, blue color filters for blue (B) light, etc. In some example embodiments, a color filter (not illustrated) in the transmissive region II may have a thickness substantially smaller than that of the color filter 40 in the reflective region I. In this case, the color filter in the transmissive region II may be located on the second electrode 80 or the second substrate 90. Alternatively, the color filter in the transmissive region II may be disposed between the second electrode 80 and the second substrate 90.

In example embodiments, the color filter 40 and the memory structure 20 may be disposed on one first substrate 10 instead of separate substrates, so that processes for manufacturing the liquid crystal display device may be simplified. Such a configuration may also facilitate a reduction in an aperture ratio of the liquid crystal display device caused by a mis-alignment between the color filter 40 and the memory structure 20. Furthermore, a cross-talk problem that may result from a small distance, i.e., an insufficient distance, between the first electrode 50 and the switching device in the memory structure 20, may be prevented. For example, by positioning the color filter 40 between the memory structure 20 and the first electrode 50 a proper distance may be provided to avoid cross-talk.

In example embodiments, a second cell gap (y1) in the transmissive region II of the liquid crystal display device may be substantially larger than a first cell gap (x1) in the reflective region I due to the color filter 40, the memory structure 20, and the insulation layer 25 located in the reflective region I. For example, by adjusting thicknesses of the color filter 40, the memory structure 20 and/or the insulation layer 25, the second cell gap (y1) in the transmissive region II may be maintained substantially larger by a factor of an integer than the first cell gap (x1) in the reflective region I. When an optical path in the reflective region I is substantially two times larger than the first cell gap (x1) in the reflective region I, the second cell gap (y1) in the transmissive region II may be maintained substantially two times larger than the first cell gap (x1) in the reflective region I. Accordingly, an optical path in the transmissive region II may be substantially the same as or substantially similar to the optical path in the reflective region I. Thus, color reproduction of the liquid crystal display device may be improved when the liquid crystal display device operates in a transflective mode.

Referring now to FIG. 1, the first electrode 50 may be disposed on the color filter 40 and the insulation layer 25. The first electrode 50 may be extended from the reflective region Ito the transmissive region II. That is, the first electrode 50 may include a first portion located in the reflective region I and a second portion located in the transmissive region II, respectively. The first portion of the first electrode 50 may cover the color filter 40 in the reflective region I, and the second portion of the first electrode 50 may contact the insulation layer 25 in the transmissive region II. In example embodiments, the first electrode 50 may serve as a pixel electrode to which a data signal may be applied from wirings such as a data line.

In the reflective region I of the liquid crystal display device, the first electrode 50 may substantially enclose the color filter 40. Accordingly, out-gassing of organic layers included in the color filter 40 may be reduced and a deterioration of the color filter 40 may be prevented. Consequently, an afterimage characteristic of the liquid crystal display device may be improved. Additionally, as described above, the first electrode 50 may be electrically coupled to the memory structure 20 through the reflection layer 30.

The first electrode 50 may include a transparent conductive material. For example the first electrode 50 may include one or more of indium tin oxide (ITO; InSnxOy), indium zinc oxide (IZO; InZnxOy), indium oxide (InOx), zinc oxide (ZnOx), tin oxide (SnOx), and titanium oxide (TiOx). The transparent conductive materials are not limited to those specifically described herein. The first electrode 50 may have a single layer structure or a multi layer structure.

The second electrode 80 may be disposed on the second substrate 90, substantially opposed to the first electrode 50. The second electrode 80 may extend from the reflective region Ito the transmissive region II. That is, the second electrode 80 may include a first portion located in the reflective region I and a second portion located in the transmissive region II. In example embodiments, the second electrode 80 may serve as a common electrode shared by a plurality of pixels of the liquid crystal display device.

Referring now to FIG. 1, the first liquid crystal structure 60 and the second liquid crystal structure 70 may be positioned in the reflective region I and transmissive region II of the liquid crystal display device, respectively. The first liquid crystal structure 60 may include first polymer networks 61 and a plurality of first liquid crystal molecules 62. Some of the first liquid crystal molecules 62 may be partially and/or entirely dispersed in the first polymer networks 61, while others of the first liquid crystal molecules 62 may be separated from the first polymer networks 61. The second liquid crystal structure 70 may include second polymer networks 71 and a plurality of second liquid crystal molecules 72. Some of the second liquid crystal molecules 72 may be partially and/or entirely dispersed in the second polymer networks 71, while others of the second liquid crystal molecules 72 may be separated from the second polymer networks 71.

In example embodiments, the liquid crystal display device may not include a particular isolation member for isolating the reflective region I and the transmissive region II. For example, the first and the second liquid crystal structures 60 and 70 may be arranged adjacent to one another without a spacer or an isolation wall therebetween. In example embodiments, a first density of the first liquid crystal molecules 62 in the reflective region I may be substantially the same as a second density of the second liquid crystal molecules 72 in the transmissive region II. In some example embodiments, the first density of the first liquid crystal molecules 62 in the reflective region I may be substantially smaller than the second density of the second liquid crystal molecules 72 in the transmissive region II.

The first and the second polymer networks 61 and 71 in the first and the second liquid crystal structures 60 and 70, respectively, may be obtained using reactive mesogen (RM), monomers for photo polymerization, photo initiator, etc. Examples of the reactive mesogen in the first and the second polymer networks 61 and 71 may include monomer reactive mesogen, ologomer reactive mesogen, polymer reactive mesogen, etc. In example embodiments, the first and the second polymer networks 61 and 71 in the first and the second liquid crystal structure 60 and 70, respectively, may be in a range of about 5% to about 50% by weight based on a total weight of the first and the second liquid crystal structures 60 and 70. The first and the second liquid crystal molecules 62 and 72 dispersed in the first and the second polymer networks 61 and 71, respectively, may be at least partially captured by the first and the second polymer networks 61 and 71, or may be separate from the first and the second polymer networks 61 and 71.

According to example embodiments, movement of the first and/or the second liquid crystal molecules 62 and/or 72 may be controlled or confined by the first and/or the second polymer networks 61 and/or 71. Therefore, when the first substrate 10 or the second substrate 90 are pushed, a pooling phenomenon of the liquid crystal display device caused by continuous sloshing of the first and the second liquid crystal molecules 62 and 72 may be reduced or prevented by the first and the second polymer networks 61 and 71. A member for controlling and confining the first and the second liquid crystal molecules 62 and 72, such as an additional black matrix, may not be needed. Thus, the aperture ratio of the liquid crystal display device may be further improved.

FIG. 2 illustrates a cross sectional view of an operation of a liquid crystal display device in accordance with example embodiments. In example embodiments, the liquid crystal display device illustrated in FIG. 2 may operate in a white mode when the liquid crystal display device illustrated in FIG. 1 operates in a black mode.

Referring to FIG. 2, when an electric field is not generated between the first electrode 50 and the second electrode 80, the first and the second liquid crystal molecules 62 and 72 in the first and the second liquid crystal structures 60 and 70 may be arranged substantially in an irregular direction. Therefore, light reflected by the reflection layer 30 in the reflective region I may be scattered by the first polymer networks 61 and the irregularly arranged first liquid crystal molecules 62. Additionally, light incident into the transmissive region II may be scattered by the second polymer networks 71 and the irregularly arranged second liquid crystal molecules 72. The scattering effect of light may be caused by the reflection index difference between the first and the second polymer networks 61 and 71 and the first and the second liquid crystal molecules 62 and 72. The scattering effect of light may simultaneously occur with the phase shift effect of light so that the liquid crystal display device may operate in the white mode. The phase shift effect of light may be caused by the first and the second liquid crystal molecules 62 and 72.

As illustrated in FIG. 1, when a voltage is applied to the first and the second electrode 50 and 80, and an electric field is generated between the first electrode 50 and the second electrode 80, the first and the second liquid crystal molecules 62 and 72 of the first and the second liquid crystal structures 60 and 70 may be oriented along a specific direction. Thus, the liquid crystal display device may be operated in the black mode. When the reflective index of the first and the second polymer networks 61 and 71 is substantially the same as the reflective index of the first and the second liquid crystal molecules 62 and 72, oriented along a specific direction, a scattering effect of the light in the reflective region I and the transmissive region II may disappear. In other words, light reflected by the reflection layer 30 in the reflective region I may not be scattered; and light incident into the transmissive region II may not be scattered by second liquid crystal molecules 72 oriented along a specific direction. Light may, thereby, penetrate the second crystal structure 70. Accordingly, the amount of light reflected into a user's view may be reduced, so that the liquid crystal display device may be operated in the black mode. In other words, when the light is less scattered in the reflective region I and the transmissive region II, the liquid crystal display device may have a lower brightness

According to example embodiments, the liquid crystal display device may operate in the white mode and the black mode depending on a degree of light scattering by the first and the second polymer networks 61 and 71 and the first and the second liquid crystal molecules 62 and 72. According to some embodiments, an additional polarization plate may not be required on the first substrate 10 and/or the second substrate 90. Therefore, a construction of the liquid crystal display device may be relatively simple, and a cost of manufacturing the liquid crystal display device may be further decreased. Furthermore, the absence of the particular polarization plate may improve a light transmittance, so that light efficiency of the liquid crystal display device may be improved.

According to example embodiments, movement of the first and the second liquid crystal molecules 62 and 72 may be controlled or confined by the first and the second polymer networks 61 and 71 in the reflective region I and the transmissive region II of the liquid crystal display device. Therefore, an isolation member, such as an isolation wall, for preventing undesired movement of the first and the second liquid crystal molecules 62 and 72 may not be needed. When the first substrate 10 and/or the second substrate 90 may be pressed by a user, undesired movement of the first and the second liquid crystal molecules 62 and 72 in the reflective region I and the transmissive region II may be reduced, prevented, or confined by the first and the second polymer networks 61 and 71. As a result, the pooling phenomena of the liquid crystal display device may be reduced or prevented, and also bruising phenomena of the liquid crystal display device may be reduced or suppressed by improving restoration speed of the first and the second liquid crystal molecules 62 and 72 toward initial orientation.

Although the liquid crystal display device having the vertical alignment mode is described with reference to FIGS. 1 and 2, the liquid crystal structure according to example embodiments, may be employed in other liquid crystal display devices having various modes, such as an in-plane switching (IPS) mode, a fringe field switching (FFS) mode, a twisted nematic (TW or TN) mode, an electrically controlled birefringence (ECB) mode, etc.

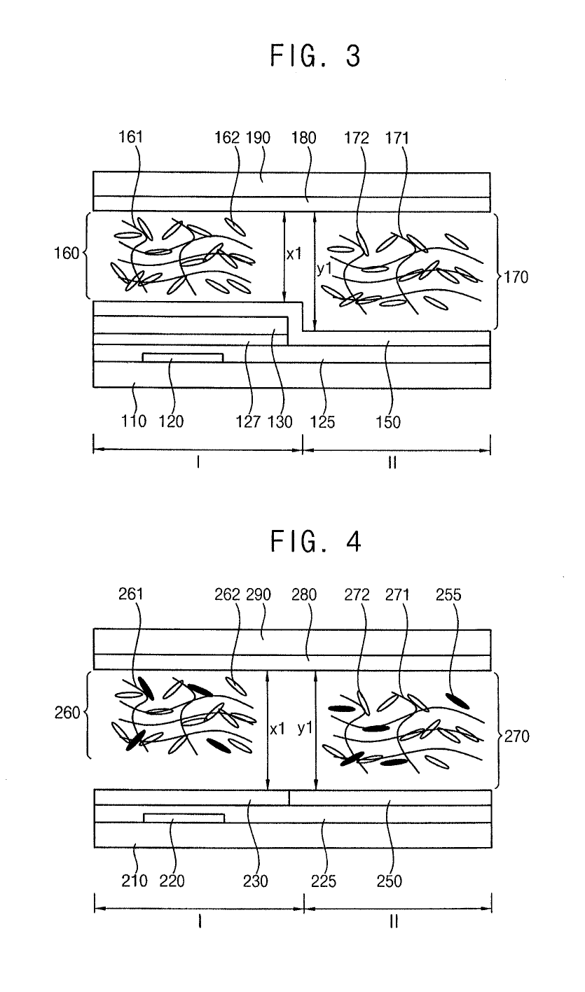

FIG. 3 illustrates a cross sectional view of a liquid crystal display device in accordance with some example embodiments. The liquid crystal display device illustrated in FIG. 3 may have a construction substantially the same as or substantially similar to that of the liquid crystal display device described with reference to FIG. 1 except for a color filter and a black matrix.

Referring to FIG. 3, a liquid crystal display device may include a first substrate 110, a memory structure 120, an insulation layer 125, a black matrix 127, a reflection layer 130, a first electrode 150, a first liquid crystal structure 160, a second liquid crystal structure 170, a second electrode 180, and a second substrate 190. Each of the first substrate 110 and the second substrate 190 may have a reflective region I and a transmissive region II.

In example embodiments, the memory structure 120 may be located on the first substrate 110 in the reflective region I. The insulation layer 125 may cover the memory structure 120 and may exist on the first substrate 110 in the reflective region I and the transmissive region II. The insulation layer 125 may include a first opening partially exposing the memory structure 120 and may have a substantially level surface.

The black matrix 127 may be disposed on the insulation layer 125 in the reflective region I. That is, the black matrix 127 may be positioned only in the reflective region I. The black matrix 127 may include a second opening (not illustrated) at least portion of which may be in fluid communication with the first opening (not illustrated) in the insulation layer 125. Additionally, the black matrix 127 may include an organic material. For example, the black matrix 127 may include a photocurable organic material containing an acryl polymer. The black matrix 127 may be disposed under the reflection layer 130 including a cholesteric liquid crystal polymer. The reflection layer 130 having the cholesteric liquid crystal polymer may selectively reflect related colors of light by Bragg reflection. If the light is reflected by a metal layer included in the memory structure 120 under the reflection layer 130, red light, green light, and blue light may be reflected simultaneously, so that related colors of light may not be selectively reflected in the reflective region I. In example embodiments, the black matrix 127 may be positioned under the reflection layer 130 to prevent a reflection by the metal layer, such that related colors of light may be selectively reflected in the reflective region I. Therefore, the liquid crystal display device may display color images without requiring a color filter.

The reflection layer 130 may be disposed on the black matrix 127. In this case, the reflection layer 130 may be positioned only in the reflective region I. In example embodiments, the reflective layer 130 may include the cholesteric liquid crystal polymer. The reflection layer 130 may be electrically connected to the memory structure 120 through the first opening in the insulation layer 125 and the second opening in the black matrix 127. That is, the reflection layer 130 may contact the memory structure 120 passing through the first opening in the insulation layer 125 and the second opening in the black matrix 127.

In example embodiments, when an electric field (E) applied to a cholesteric liquid crystal of the cholesteric liquid crystal polymer is greater than a first electric field (E1), the cholesteric liquid crystal of the reflection layer 130 may be arranged to be in a homeotropic state. When the electric field (E) becomes less than a second electric field (E2) in the homeotropic state, the cholesteric liquid crystal may be arranged in a planar state. When the electric field (E) is greater than the first electric field (E1) and less than the second electric field (E2) in the homeotropic state, the cholesteric liquid crystal may be arranged in a focal conic state. The cholesteric liquid crystal in the planar state may reflect light having a specific wavelength, and the cholesteric liquid crystal in the focal conic state may scatter the light. Furthermore, the cholesteric liquid crystal in the planar state may reflect light having a specific wavelength corresponding to a pitch of the cholesteric liquid crystal multiplied by a reflective index of the cholesteric liquid crystal. Therefore, light having a specific wavelength may be reflected by adjusting the pitch of the cholesteric liquid crystal of the reflection layer 130 in the reflective region I. The pitch of the cholesteric liquid crystal may be changed according to the amount of a chiral dopant included in the cholesteric liquid crystal. Therefore, the colors in the planar state may include various colors, such as green, red, blue, etc., to be displayed in full color. For example, the cholesteric liquid crystal arranged to have a first pitch may reflect red light in the planar state. The cholesteric liquid crystal arranged to have a second pitch may reflect green light in the planar state. The cholesteric liquid crystal arranged to have a third pitch may reflect blue light in the planar state. Therefore, the liquid crystal display device may display color images such as red, green, and blue without a color filter.

As shown in FIG. 3, the first electrode 150 may be disposed on the reflection layer 130 and the insulation layer 125. That is, the first electrode 150 may cover the reflection layer 130 in the reflection region I and may contact the insulation layer 125 in the transmissive region II. The first electrode 150 may include a transparent conductive material. In example embodiments, the first electrode 150 may seal exposed surfaces of the reflection layer 130. In other words, the first electrode 150 may cover an upper surface and a side surface of the reflection layer 130. When the first electrode 150 encloses the reflection layer 130, an additional capping member for the cholesteric liquid crystal polymer of the reflection layer 130 may not be required.

As illustrated in the FIG. 3, the first liquid crystal structure 160 and the second liquid crystal structure 170 may be positioned in the reflective region I and transmissive region II of the liquid crystal display device, respectively. The first liquid crystal structure 160 may include first polymer networks 161 and a plurality of first liquid crystal molecules 162. The second liquid crystal structure 170 may include second polymer networks 171 and a plurality of second liquid crystal molecules 172. In the embodiment shown in FIG. 3, the first and the second polymer networks 161 and 171 and the first and the second liquid crystal molecules 162 and 172 may be arranged substantially the same as or substantially similar to the first and the second polymer networks 61 and 71 and the first and the second liquid crystal molecules 62 and 72, as the embodiment described with reference to FIG. 1.

The second substrate 190 may be disposed to be substantially opposed to the first substrate 110. Additionally, the second electrode 180 may be located on the second substrate 190 to be substantially opposed to the first electrode 150. The second electrode 180 may include a transparent conductive material.

According to example embodiments, a light of a specific wavelength may be reflected depending on the pitch and the reflective index of the cholesteric liquid crystal polymer of the reflection layer 130. Thus, the liquid crystal display device may display color images without a color filter in the reflective region I.

FIG. 4 illustrates a cross sectional view of a liquid crystal display device in accordance with some example embodiments. The liquid crystal display device illustrated in FIG. 4 may have a construction substantially the same as or substantially similar to that of the liquid crystal display device described with reference to FIG. 1, except for a first electrode, a color filter, and a color dye.

Referring to FIG. 4, a liquid crystal display device may include a first substrate 210, a memory structure 220, an insulation layer 225, a reflection layer 230, a first electrode 250, a color dye 255, a first liquid crystal structure 260, a second liquid crystal structure 270, a second electrode 280, and a second substrate 290. Each of the first substrate 210 and the second substrate 290 may have a reflective region I and a transmissive region II.

In example embodiments, the memory structure 220 may be disposed on the first substrate 210 in the reflective region I. The insulation layer 225 may cover the memory structure 220 and may be located on the first substrate 210 in the reflective region I and the transmissive region II. The insulation layer 225 may include a first opening (not illustrated) partially exposing the memory structure 220.

In example embodiments, the reflection layer 230 may be positioned on the insulation layer 225 in the reflective region I, and the first electrode 250 may be disposed on the insulation layer 225 in the transmissive region II. That is, the reflection layer 230 and the first electrode 250 may be located in the reflective region I and the transmissive region II of the liquid crystal display device, respectively.

The reflection layer 230 may be electrically connected to the memory structure 220 through the first opening in the insulation layer 225. In example embodiments, the reflection layer 230 may fill the first opening in the insulation layer 225 to make contact with the memory structure 220. In some example embodiments, contacts (not illustrated), plugs (not illustrated), pads (not illustrated) for electrically connecting the reflection layer 230 and the memory structure 220 may fill the first opening. The reflection layer 230 may include a material having a relatively high reflectivity. For example, the reflection layer 230 may include one or more of aluminum (Al), molybdenum (Mo), tungsten (W), chrome (Cr), platinum (Pt), silver (Ag), an alloy thereof, etc. The materials suitable for inclusion in the reflective layer 230 may not be limited to those specifically described herein. Furthermore, the reflection layer 230 may have a single layer structure or a multi layer structure.

In example embodiments, the reflective layer 230 may be electrically coupled to the memory structure 220. The reflective layer 230 may include a conductive material so that the reflective layer 230 may serve as an electrode in the reflective region I. Accordingly, the reflective layer 230 may serve as a pixel electrode to which a data signal may be applied from wirings such as the data line in the reflective region I of the liquid crystal display device, and the first electrode 250 may serve as the pixel electrode in the transmissive region II.

The first electrode 250 may be disposed on the insulation layer 225 to make contact with the reflection layer 230. In this case, the first electrode 250 may be located in the transmissive region II. As described above, the first electrode 250 may serve as the pixel electrode to which a data signal may be applied from wirings such as the data line in the transmissive region II. Additionally, the first electrode 250 may be electrically connected to the memory structure 220 through the reflection layer 230. The first electrode 250 may include a transparent conductive material, and may have a single layer structure or a multi layer structure.

In example embodiments, the first electrode 250 in the transmissive region II may have a thickness substantially the same as or substantially similar to that of the reflection layer 230 in the reflective region I. Therefore, a first cell gap (x1) in the reflective region I may be substantially the same as, or substantially similar to, a second cell gap (y1) in the transmissive region II of the liquid crystal display device. As a result, an optical path in the reflective region I may be substantially two times larger than an optical path in the transmissive region II, so that color reproduction of the liquid crystal display device may be largely improved. Additionally, the first cell gap (x1) in the reflective region I may be maintained substantially the same as or substantially similar to the second cell gap (y1) in the transmissive region II, and thus some problems such as a particulate failure caused by a cell gap difference, a diagonal stain caused by an orientation failure, and breaking to a liquid crystal texture break, may be avoided.

The first liquid crystal structure 260 and the second liquid crystal structure 270 may be disposed in the reflective region I and transmissive region II of the liquid crystal display device, respectively. The first liquid crystal structure 260 may include first polymer networks 261, dispersed first liquid crystal molecules 262, and the color dye 255. The second liquid crystal structure 270 may include second polymer networks 271, dispersed second liquid crystal molecules 272, and the color dye 255. In this case, the first and the second polymer networks 261 and 271 and the first and the second liquid crystal molecules 262 and 272 may be arranged substantially the same as or substantially similar to the first and the second polymer networks 61 and 71 and the first and the second liquid crystal molecules 62 and 72 described with reference to FIG. 1.

The second substrate 290 may be substantially opposed to the first substrate 210. Additionally, the second electrode 280 may be located on the second substrate 290 and be substantially opposed to the first electrode 250 and the reflection layer 230. In this case, the second electrode 180 may extend from the reflective region Ito the transmissive region II, so that a first portion of the second electrode 280 may be positioned on the reflection layer 230 in the reflective region I, and a second portion of the second electrode 280 may be positioned on the first electrode 250 in the transmissive region II.

In example embodiments, the color dye 255 may be added in the first and the second liquid crystal structures 260 and 270 in the reflective region I and the transmissive region II. In some example embodiments, only the first liquid crystal structure 260 in the reflective region I may include the color dye 255. In this case, a color filter (not illustrated) may be additionally disposed on the second substrate 290 in the transmissive region II. In some example embodiments, the color dye 255 may be included only in the transmissive region II.

The color dye 255 may be dispersed in the first and the second polymer networks 261 and 271, and may be partially overlapped by the first and the second liquid crystal molecules 262 and 272. The color dye 255 may include a red color dye capable of displaying red light, a green color dye capable of displaying green light, and a blue color dye capable of displaying blue light. In example embodiments, a density of the color dye 255 located in the reflective region I may be substantially smaller than that of the color dye 255 located in the transmissive region II. In the liquid crystal display device including the color dye 255, when light incident in the transmissive region II penetrates the color dye 255, light having a specific wavelength may be reflected. Moreover, light incident in the reflective region I may have an optical path substantially two times larger than an optical path in the transmissive region II, thereby increasing a possibility that light incident in the reflective region I may reach the color dye 255. Thus, more improved color purity may be obtained in the reflective region I of the liquid crystal display device.

According to example embodiments, the liquid crystal display device may include the color dye 255 in the reflective region I and/or the transmissive region II, so that the liquid crystal display device may display color images without a color filter.

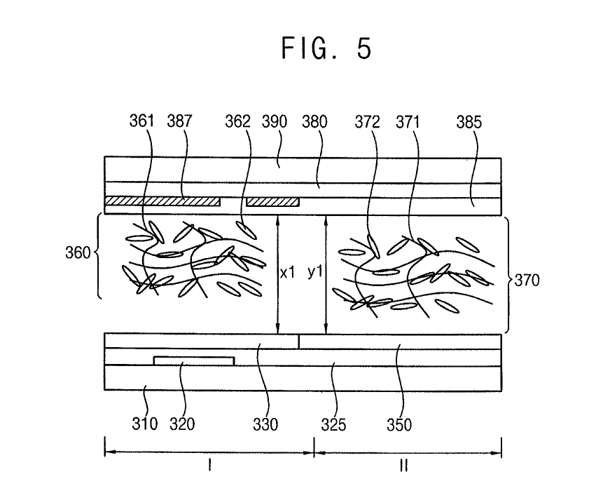

FIG. 5 illustrates a cross sectional view of a liquid crystal display device in accordance with some example embodiments. The liquid crystal display device illustrated in FIG. 5 may have a construction substantially the same as, or substantially similar to, that of the liquid crystal display device described with reference to FIG. 1 except for a color dye, a color filter, and a protection layer.

Referring to FIG. 5, a liquid crystal display device may include a first substrate 310, a memory structure 320, an insulation layer 325, a reflection layer 330, a first electrode 350, a first liquid crystal structure 360, a second liquid crystal structure 370, a second electrode 380, a second substrate 390, a color filter 387, and a protection layer 385. Each of the first substrate 310 and the second substrate 390 may have a reflective region I and a transmissive region II.

In example embodiments, the color filter 387 may be disposed on the second electrode 380 which may be positioned on the second substrate 390. Namely, the color filter 387 may be positioned on the second electrode 380 in the reflective region I. The color filter 387 may selectively filter related colors of light reflected by the reflection layer 330. In this case, the color filter 387 may include red color filters for red (R) light, green color filters for green (G) light, blue color filters for blue (B) light, etc. The color filter 387 positioned in the reflective region I may include a light opening or a light hole. The light opening or the light hole may penetrate the color filter 387 to expose the first liquid crystal structure 360 in the reflective region. Light incident in the reflective region I may be passed through the light opening or the light hole, so that light efficiency of the liquid crystal display device may be improved. Additionally, when the color filter 387 includes the light opening or the light hole, an exposure process for forming the first liquid crystal structure 360 may be easily performed.

As described in FIG. 5, the protection layer 385 may be positioned on the second electrode 380 to cover the color filter 387. The second electrode 380 may serve as a common electrode shared by a plurality of pixels of the liquid crystal display device. The protection layer 385 may cover the color filter 387 in the reflective region I and may contact the second electrode 380 in the transmissive region II. The protection layer 385 may include a transparent insulating material. The protection layer 385 may substantially enclose the color filter 387, and an out-gassing of organic layers included in the color filter 387 may be prevented. A deterioration of the color filter 387 may be prevented by the protection layer 385, so that an afterimage characteristic of the liquid crystal display device may be improved. In some example embodiments, the protection layer 385 may be positioned only in the reflection region I. In this case, a first cell gap (x1) in the reflective region I may be substantially smaller than a second cell gap (y1) in the transmissive region II.

As illustrated in FIG. 5, the first liquid crystal structure 360 and the second liquid crystal structure 370 may be disposed in the reflective region I and transmissive region II of the liquid crystal display device, respectively. The first liquid crystal structure 360 may include first polymer networks 361 and dispersed first liquid crystal molecules 362. The second liquid crystal structure 370 may include second polymer networks 371 and dispersed second liquid crystal molecules 372. In this case, the first and the second polymer networks 361 and 371 and the first and the second liquid crystal molecules 362 and 372 may be arranged substantially the same as or substantially similar to the first and the second polymer networks 61 and 71 and the first and the second liquid crystal molecules 62 and 72, described with reference to FIG. 1.

According to example embodiments, the liquid crystal display device may include the color filter 387, including the light opening, so that the liquid crystal display device may display full color images with an improved light efficiency.

In some example embodiments, the liquid crystal display device may include a first liquid crystal display panel and a second liquid crystal display panel, sequentially stacked. The first liquid crystal display panel may have a construction substantially the same as or substantially similar to that of a liquid crystal display panel of a conventional transmissive liquid crystal display device. Additionally, the second liquid crystal display panel may have a construction substantially the same as or substantially similar to one of the above-described liquid crystal display devices, including the reflective region I and the transmissive region II. In this case, the second liquid crystal display panel may be combined with the first liquid crystal display panel in a variety of ways such as folder type, slide type, etc. When the first liquid crystal display panel serves as a main display panel, the second liquid crystal display panel may serve as a cover display panel.

According to example embodiments, when the liquid crystal display device includes the first and the second liquid crystal display panels, the transflective second liquid crystal display panel may cover the first liquid crystal display panel. In such embodiments, when the first liquid crystal display panel is off, only the second liquid crystal display panel may be operated. Accordingly, using the scattering reflection of the second liquid crystal panel, the liquid crystal display device may be used as a reflective display device, e-book, etc. The liquid crystal display device may include the memory structure which facilitates operation of the liquid crystal display device with relatively low power.

In some example embodiments, when the second liquid crystal display panel covers the first liquid crystal display panel, the first liquid crystal display panel may display a data. That is, when the transflective second liquid crystal display panel is on, the second liquid crystal display panel may be operated in a transparent mode, as described above with reference to FIGS. 1 and 2, such that the user may observe images displayed in the first liquid crystal display panel while the second liquid crystal display panel covers the first liquid crystal display panel. In this case, to improve the light transmittance of the first liquid crystal display panel, the second liquid crystal display panel may not include a polarizing member, a color filter, etc. Alternatively, when the second liquid crystal display does not cover the first liquid crystal display, the second liquid crystal display may serve as a transparent keyboard. Bruising phenomena or pooling phenomena may not occur in the transflective second liquid crystal display panel, such that the second liquid crystal display panel may be used as a touch solution liquid crystal display device.

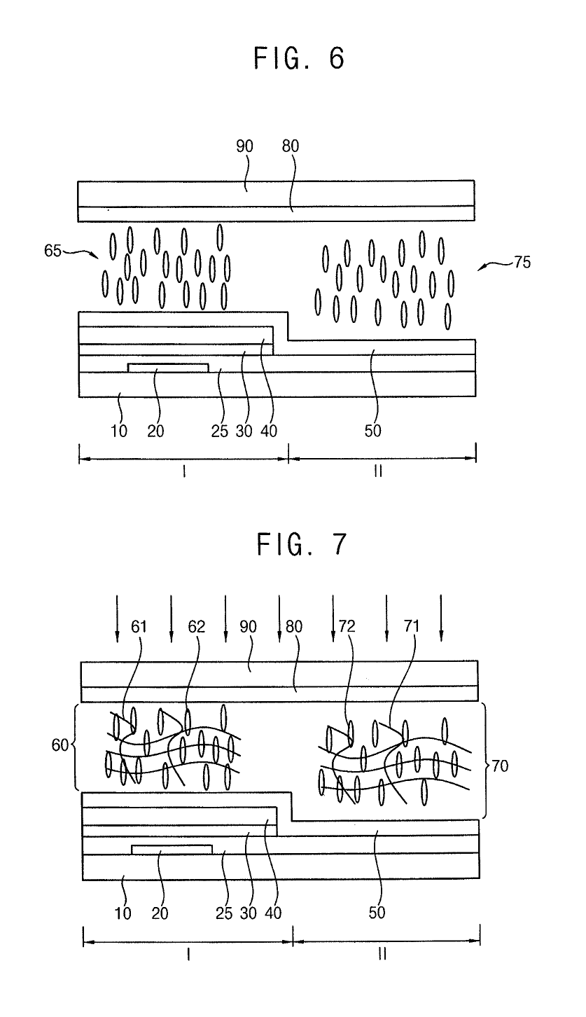

FIGS. 6 and 7 illustrate cross sectional views of a method of manufacturing a liquid crystal display device in accordance with example embodiments. The liquid crystal display device obtained by the method illustrated in FIGS. 6 and 7 may have a construction substantially the same as or substantially similar to that of the liquid crystal display device described with reference to FIG. 1. However, those ordinary skilled in the art would understand that the method according to example embodiments may be properly and easily modified to manufacture one of the liquid crystal display devices described with reference to FIGS. 3 to FIG. 5.

Referring to FIG. 6, a memory structure 20 may be formed on a first substrate 10 in a reflective region I. The memory structure 20 may include wirings, a switching element, an insulation layer, etc.

An insulation layer 25 may be formed on the first substrate 10 in the reflective region I and a transmissive region II to cover the memory structure 20. The insulation layer 25 may be formed using oxide, oxynitride, nitride, etc. Alternatively, the insulation layer 25 may be formed using a transparent organic material.

A reflection layer 30 may be formed on the insulation layer 25 in the reflective region I. That is, the reflection layer 30 may be formed on a portion of the insulation layer 25 where the memory structure 20 may be located. The reflection layer 30 may be formed using a material having a relatively high reflectivity. Additionally, the reflection layer 30 may be formed on the insulation layer by a sputtering process, a printing process, a spray process, a chemical vapor deposition (CVD) process, an atomic layer deposition (ALD) process, etc. In example embodiments, the reflection layer 30 may be formed in the reflective region I of the first substrate 10 by forming a first conductive layer (not illustrated) on the insulation layer 25 and patterning the first conductive layer by a photolithography process.

A color filter 40 may be formed on the reflection layer 30 in the reflective region I. In example embodiments, a red color filter, a green color filter, and a blue color filter may be formed in related pixel regions. In some example embodiments, a color dye may be added in a process of forming the liquid crystal structure instead of forming the color filter 40.

A first electrode 50 may be formed on the color filter 40 and the insulation layer 25. The first electrode 50 may cover the color filter 40 in the reflective region I and may cover the insulation layer 25 in the transmissive region II. The first electrode 50 may substantially enclose the color filter 40. The first electrode 50 may be formed using a transparent conductive material. Additionally, the first electrode 50 may be formed by a sputtering process, a printing process, the spray process, a chemical vapor deposition (CVD) process, an atomic layer deposition (ALD) process, etc. In example embodiments, the first electrode 50 may be obtained by forming a second conductive layer (not illustrated) on the color filter 40 and the insulation layer 25 and by patterning the second conductive layer.

Referring now to FIG. 6, a second electrode 80 may be formed on a second substrate 90. The second electrode 80 may be formed using a transparent conductive material by a sputtering process, a printing process, a spray process, a chemical vapor deposition (CVD) process, an atomic layer deposition (ALD) process, etc. The second electrode 80 may be formed on the second substrate 90 from the reflective region I to the transmissive region II.

In some example embodiments, an additional member may be provided between the first substrate 10 and the second substrate 90, and the first substrate 10 may be combined with the second substrate 90, such that a gap (e.g., a predetermined gap) is maintained therebetween. The additional member may include a column spacer, a member for ensuring a cell gap of the liquid crystal display device, a sealing member, etc.

Referring to FIG. 6, a first preliminary liquid crystal structure 65 and a second preliminary liquid crystal structure 75 may be formed between the first substrate 10 and the second substrate 90. In this case, the first preliminary liquid crystal structure 65 may be formed in the reflective region I, and the second preliminary liquid crystal structure 75 may be formed in the transmissive region II. In example embodiments, the first preliminary liquid crystal structure 65 may have a constitution substantially the same as or substantially similar to the second preliminary liquid crystal structure 75. For example, each of the first and the second preliminary liquid crystal structures 65 and 75 may be formed using liquid crystal molecules, monomers, a photoinitiator, reactive mesogens, etc. Each of the first and the second preliminary liquid crystal structures 65 and 75 may be formed by a printing process, a spray process, etc. The first and the second preliminary liquid crystal structures 65 and 75 may be injected into a space between the first and the second substrates 10 and 90. Alternatively, the first and the second preliminary liquid crystal structures 65 and 75 may be coated on at least one of the first substrate 10 and the second substrate 90.

Referring to FIG. 7, an exposure process may be performed about the first and the second preliminary liquid crystal structures 65 and 75 in the reflective region I and the transmissive region II. The exposure process for the first and the second preliminary liquid crystal structures 65 and 75 may include an ultraviolet (UV) light exposure process.

In the exposure process, according to example embodiments, light such as UV light may be irradiated into the first and the second preliminary liquid crystal structures 65 and 75 in the reflective region I and the transmissive region II. Thus, polymer seeds may be generated in the reflective region I and the transmissive region II. The monomers may be polymerized by the polymer seeds to form first and second polymer networks 61 and 71 in the reflective region I and the transmissive region II, respectively. First and second liquid crystal molecules 62 and 72 in the reflective region I and the transmissive region II may be partially and/or entirely dispersed in the first and the second polymer networks 61 and 71, respectively. As a result, a first liquid crystal structure 60 having the first liquid crystal molecules 62 and the first polymer networks 61 may be formed in the reflective region I, while a second liquid crystal structure 70 having the second liquid crystal molecules 72 and the second polymer networks 71 may be formed in the transmissive region II. The liquid crystal display device may be obtained by formations of the first and the second liquid crystal structures 60 and 70.

According to example embodiments, a movement or a flow of first and second liquid crystal molecules may be partially and/or entirely restricted, so that movement of a first and a second liquid crystal structures may be prevented. Therefore, problems such as a pooling phenomenon and a bruising phenomenon may be prevented while improving a light efficiency of a liquid crystal display device. Additionally, the liquid crystal display may have a simple constitution, and a manufacturing process of the liquid crystal display may be simple. Furthermore, using a memory structure, a power consumption of the liquid crystal display may be reduced, and a color reproduction of the liquid crystal display device may be improved by adjusting cell gaps in a reflective region I and a transmissive region II. The liquid crystal display, in accordance with example embodiments, may be used not only in a conventional display device but also a variety of electronic devices such as an e-book and customer products.

Transmissive type liquid crystal display devices may have some disadvantages, such as a relatively high power consumption caused by the backlight and a poor visibility in an environment where an external light exists. Meanwhile, the reflective type liquid crystal display device may be operated with a relatively low power due to the external light source such as a natural light, however, the reflective type liquid crystal display device may not display bright images under a relatively dark environment.

A conventional transflective type liquid crystal display device may overcome some of the disadvantages of the conventional transmissive type liquid crystal display devices and reflective type liquid crystal display devices. For example, conventional transflective type liquid crystal display devices may have a relatively low power consumption and a good visibility under a dark environment. In this case, the transflective type liquid crystal display device may have a dual cell gap structure in which a cell gap of the transmissive region may be substantially two times larger than a cell gap of the reflective region. In order to reduce the cell gap in the reflective region, a step may be formed on a lower substrate having a thin film transistor and/or an upper substrate having a color filter. However, various failures may occur in manufacturing processes for the conventional transflective type liquid crystal display device. For example, because the cell gap in the reflective region is smaller than the cell gap in the transmissive region, a process failure may be caused by particles generated in the manufacturing procedure, an orientation failure of the liquid crystal molecules may be caused by the step, and a break of a liquid crystal texture may be generated in the manufacturing processes, so that the liquid crystal display device may deteriorated characteristics such as a bruising of a liquid crystal layer , a reduction of a contrast ratio, etc.

In contrast, the liquid crystal display device, according to embodiments, may operate with low power while ensuring improved electrical and mechanical characteristics.

According to example embodiments, a movement or a flow of first and second liquid crystal molecules may be partially and/or entirely restricted, so that a continuous sloshing of a first liquid crystal structure and a second liquid crystal structure caused by an external pressure may be prevented. Therefore, problems such as a pooling phenomenon and a bruising phenomenon may be prevented while improving a light efficiency of a liquid crystal display device. Additionally, the liquid crystal display may have a simple constitution, and also manufacturing processes of the liquid crystal display may be simple. Furthermore, use of a memory structure and power consumption of the liquid crystal display may be reduced. A color reproduction of the liquid crystal display device may be improved by adjusting cell gaps in a reflective region and a transmissive region. The liquid crystal display according to example embodiments may be employed in general display apparatuses and various recent electronic apparatuses such as e-books, customer products, etc.

The foregoing is illustrative of example embodiments, and is not to be construed as limiting thereof. Although a few example embodiments have been described, those skilled in the art will readily appreciate that many modifications are possible in the example embodiments without materially departing from the novel teachings and advantages of example embodiments. Accordingly, all such modifications are intended to be included within the scope of example embodiments as defined in the claims. In the claims, means-plus-function clauses are intended to cover the structures described herein as performing the recited function, and not only structural equivalents, but also equivalent structures. Therefore, it is to be understood that the foregoing is illustrative of example embodiments and is not to be construed as limited to the specific embodiments disclosed, and that modifications to the disclosed example embodiments, as well as other example embodiments, are intended to be included within the scope of the appended claims. The invention is defined by the following claims, with equivalents of the claims to be included therein.

What is claimed is:

1. A liquid crystal display device, comprising:
a first substrate having a reflective region and a transmissive region;
a second substrate corresponding to the first substrate;
a first liquid crystal structure disposed between the first substrate and the second substrate in the reflective region, the first liquid crystal structure including first polymer networks and first liquid crystal molecules; and
a second liquid crystal structure disposed between the first substrate and the second substrate in the transmissive region, the second liquid crystal structure including second polymer networks and second liquid crystal molecules.

2. The liquid crystal display device of claim 1, wherein the first liquid crystal molecules are partially or totally dispersed in the first polymer networks and the second liquid crystal molecules are partially or totally dispersed in the second polymer networks.

3. The liquid crystal display device of claim 1, wherein at least one of the first and the second liquid crystal structures includes a color dye.

4. The liquid crystal display device of claim 1, further comprising:
a memory structure disposed on the first substrate in the reflective region; and
an insulation layer covering the memory structure on the first substrate.

5. The liquid crystal display device of claim 4, further comprising:
a first electrode disposed on the first substrate in the reflective region and the transmissive region; and
a second electrode disposed on the second substrate.

6. The liquid crystal display device of claim 5, wherein a first cell gap between the first electrode and the second electrode in the reflective region is smaller than a second cell gap between the first electrode and the second electrode in the transmissive region.

7. The liquid crystal display device of claim 5, wherein the first electrode is electrically connected to the memory structure.

8. The liquid crystal display device of claim 5, further comprising a reflection layer disposed between the first electrode and the first substrate in the reflective region.

9. The liquid crystal display device of claim 8, wherein the reflection layer includes a cholesteric liquid crystal polymer.

10. The liquid crystal display device of claim 9, further comprising a black matrix disposed between the reflection layer and the first substrate.

11. The liquid crystal display device of claim 8, further comprising a color filter disposed between the reflection layer and the first electrode.

12. The liquid crystal display device of claim 11, wherein the first electrode covers exposed surfaces of the reflection layer and the color filter.

13. The liquid crystal display device of claim 4, further comprising:
a reflection layer disposed on the first substrate in the reflective region;
a first electrode disposed on the first substrate in the transmissive region; and
a second electrode disposed on the second substrate.

14. The liquid crystal display device of claim 13, wherein a first cell gap between the first electrode and the second electrode in the reflective region is the same size as a second cell gap between the first electrode and the second electrode in the transmissive region.

15. The liquid crystal display device of claim 13, wherein the first electrode makes contact with the reflection layer, and the reflection layer is electrically connected to the memory structure.

16. The liquid crystal display device of claim 13, further comprising:
a color filter disposed on the second electrode in the reflective region; and
a protection layer disposed on the color filter and the second electrode.

17. The liquid crystal display device of claim 16, wherein the color filter includes an opening partially exposing the first liquid crystal structure.

18. A method of manufacturing a liquid crystal display device, the method comprising:
forming a first electrode on a first substrate having a reflective region and a transmissive region;
forming a second electrode on a second substrate corresponding to the first substrate;
combining the first substrate with the second substrate; and
forming a first liquid crystal structure between the first substrate and the second substrate in the reflective region, the first liquid crystal structure including first polymer networks and first liquid crystal molecules, and forming a second liquid crystal structure between the first substrate and the second substrate in the transmissive region, the second liquid crystal structure including second polymer networks and second liquid crystal molecules.

19. The method of claim 18, further comprising:
forming a memory structure on the first substrate in the reflective region prior to forming the first electrode; and
forming an insulation layer on the first substrate to cover the memory structure prior to forming the first electrode.

20. The method of claim 19, further comprising forming a reflection layer between the insulation layer and the first electrode in the reflective region.

21. The method of claim 20, further comprising forming a color filter between the reflection layer and the first electrode.

22. The method of claim 20, further comprising forming a black matrix between the insulation layer and the reflection layer.

23. The method of claim 18, further comprising forming a reflection layer on the first substrate in the reflective region wherein the first electrode is disposed on the first substrate in the transmissive region.

24. The method of claim 23, further comprising:
forming a color filter on the second electrode in the reflective region; and
forming a protection layer on the color filter and the second electrode.

25. The method of claim 18, wherein forming the first and the second liquid crystal structures comprises:
forming a first preliminary liquid crystal structure in the reflective region and a second preliminary liquid crystal structure in the transmissive region; and
exposing the first preliminary liquid crystal structure and the second preliminary liquid crystal structure to light.

26. The method of claim 25, further comprising adding a color dye to at least one of the first and the second preliminary liquid crystal structures.
